(19) United States
(12) Patent Application Publication
(10) Pub. No.: US 2025/0227109 A1
(43) Pub. Date: Jul. 10, 2025

(54) DETECTION OF NON-HUMAN ACTORS IN A DIGITAL INTERACTION

(71) Applicant: MASTERCARD INTERNATIONAL INCORPORATED, Purchase, NY (US)

(72) Inventors: Michael Jason Friedman, Stamford, CT (US); Stephen Dobby, North Yorkshire (GB)

(21) Appl. No.: 18/409,120

(22) Filed: Jan. 10, 2024

(51) Int. Cl. H04L 9/40

(52) U.S. Cl. CPC H04L 63/102; H04L 63/0876; H04L 63/20

(57) ABSTRACT

Systems, methods, and apparatus are described herein to authenticate a valid user in digital transactions, and more particularly, to the detection of a bot, such as a generative pretrained transformer (GPT), when performing a challenge-response authentication.

### BACKGROUND

A Completely Automated Public Turing test to tell Computers and Humans Apart (CAPTCHA) is a challenge-response authentication method to determine whether network requests and/or data originates from a human or a bot. However, with the emergence of generative artificial intelligence (AI) solutions based on large language models (LLMs), such as Generative Pre-trained Transformer 4 (GPT-4), these generative AI solutions have demonstrated an ability to solve puzzles, such as CAPTCHAs. Given the ability to bypass a popular fraud mitigation tool aimed at identifying bots and AI powered solutions, a widespread failure of this anti-fraud solution would impose significant costs to those organizations and enterprises that rely on CAPTCHA solutions. Moreover, ineffective CAPTCHA technologies may also induce significant social costs if bots were able to increase widespread sharing of misinformation.

### SUMMARY

The disclosure relates generally to authenticating a valid user in digital interactions, and in particular, detecting the presence of a bot, such as a generative pretrained transformer (GPT), when performing a challenge-response authentication.

The summary of the disclosure is given to aid understanding of authenticating valid users in digital interactions and not with an intent to limit the disclosure. The present disclosure is directed to a person of ordinary skill in the art. It should be understood that various aspects and features of the disclosure may advantageously be used separately in some instances, or in combination with other aspects and features of the disclosure in other instances. Accordingly, variations and modifications may be made to the systems, devices, and their methods of operation to achieve different effects. Certain aspects of the present disclosure provide a system, method, and non-transitory computer readable medium for authenticating a valid user in digital interactions.

Systems, methods, and apparatus are described herein for authenticating valid users in digital interactions. In one or more aspects, the disclosed technology relates to a method. In one or more cases, the method receives, from a device, a request to access one or more portions of a website during a session. In one or more cases, the method provides challenge data to the device to assess whether a user of the device is an invalid user. The challenge data may correspond to a challenge question having a high degree of difficulty. In one or more cases, the method receives data from the device. The received data may correspond to an answer to the challenge question. In one or more cases, the method determines that the received data corresponds to a correct answer to the challenge question and that the user of the device is an invalid user. In one or more cases, the method denies the requested access to the one or more portions of the website.

In one or more aspects, the disclosed technology relates to an apparatus. The apparatus may include a memory configured to store instructions and at least one processor coupled to the memory. The at least one processor may be configured to execute the instructions to receive, from a device, a request to access one or more portions of a website during a session. The at least one processor may be configured to execute the instructions to provide challenge data to the device to assess whether a user of the device is an invalid user. The challenge data may correspond to a challenge question having a high degree of difficulty. The at least one processor may be configured to execute the instructions to receive data from the device. The received data corresponds to an answer to the challenge question. The at least one processor may be configured to execute the instructions to determine that the received data corresponds to a correct answer to the challenge question and that the user of the device is an invalid user. The at least one processor may be configured to execute the instructions to deny the requested access to the one or more portions of the website.

### BRIEF DESCRIPTION OF THE DRAWINGS

The features and advantages of the present disclosure will be better understood when read in conjunction with the figures provided. Embodiments are provided in the figures for the purpose of illustrating aspects, and/or features, of the various embodiments, but the claims should not be limited to the precise arrangements, structures, features, aspects, methods, processes, assemblies, systems, or devices shown, and the arrangements, structures, features, aspects, methods, processes, assemblies, systems, and devices shown may be used singularly or in combination with other arrangements, structures, features, aspects, methods, processes, assemblies, systems, and devices.

FIG. 1 illustrates a functional block diagram of a data processing environment.

FIG. 2 is a flowchart illustrating a procedure of authenticating a valid user in a digital interaction.

FIG. 3A is an example challenge to authenticate a valid user.

FIG. 3B is another example challenge to authenticate a valid user.

FIG. 4 is a block diagram of an example computing device.

### DETAILED DESCRIPTION

The following discussion omits or only briefly describes conventional features of a data processing environment, which are apparent to those skilled in the art. It is noted that various embodiments are described in detail with reference to the drawings, in which like reference numerals represent like drawing elements throughout the figures. Reference to various embodiments does not limit the scope of the claims attached hereto. Additionally, any examples set forth in this specification are intended to be non-limiting and merely set forth some of the many possible embodiments for the appended claims. Further, particular features described herein can be used in combination with other described features in each of the various possible combinations and permutations. The objectives and advantages of the claimed subject matter will become more apparent from the following detailed description of these embodiments in connection with the accompanying drawings.

Unless otherwise specifically defined herein, all terms are to be given their broadest possible interpretation including meanings implied from the specification as well as meanings understood by those skilled in the art and/or as defined in dictionaries, treatises, etc. It must also be noted that, as used in the specification and the appended claims, the singular forms “a,” “an,” and “the” include plural referents unless otherwise specified, and that the terms “comprises” and/or “comprising,” when used in this specification, specify the presence or addition of one or more other features, aspects, steps, operations, elements, components, and/or groups thereof. Moreover, the terms “couple,” “coupled,” “operatively coupled,” “operatively connected,” and the like should be broadly understood to refer to connecting devices or components together either mechanically, electrically, wired, wirelessly, or otherwise, such that the connection allows the pertinent devices or components to operate (e.g., communicate) with each other as intended by virtue of that relationship.

Embodiments of the disclosure relate generally to authenticating a valid user in a digital interaction, and more particularly, to detecting the presence of a bot, such as a generative pretrained transformer (GPT), when performing a challenge-response authentication. Embodiments that authenticate valid users in digital interactions are described below with reference to the figures.

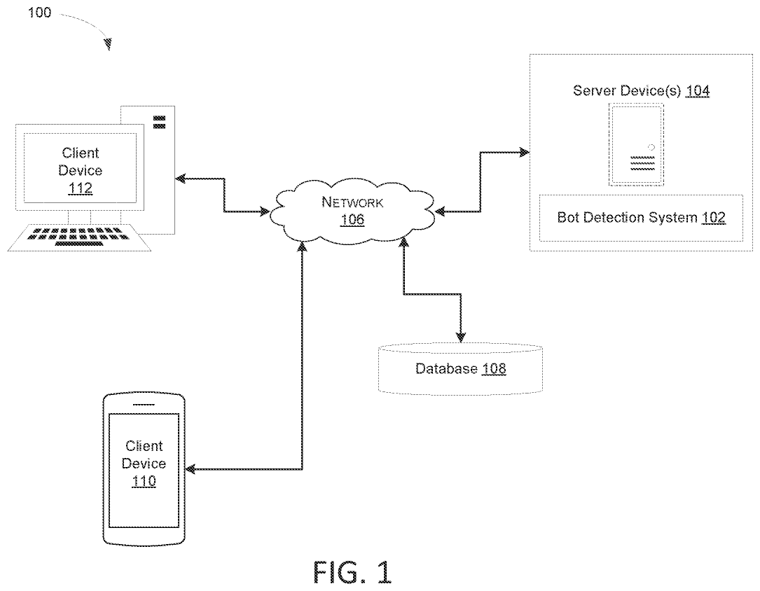

FIG. 1 is a functional block diagram of a data processing environment 100. FIG. 1 provides only an illustration of one implementation and does not imply any limitations with regard to the environments in which different embodiments may be implemented. Many modifications of the depicted environment may be made by those skilled in the art without departing from the scope of the claims. In one or more cases, the data processing environment 100 includes one or more server device(s) 104, which operates a bot detection system 102, a database 108, and one or more computing devices, such as client devices 110 and 112, coupled over a network 106. The server device(s) 104, bot detection system 102, database 108, and client devices 110 and 112 can each be any suitable computing device that includes any hardware or hardware and software combination for processing and handling information, and transmitting and receiving data among the server device(s) 104, bot detection system 102, database 108, and client devices 110 and 112. The server device(s) 104, bot detection system 102, database 108, and client devices 110 and 112 can each include one or more processors, one or more field-programmable gate arrays (FPGAs), one or more application-specific integrated circuits (ASICs), one or more state machines, digital circuitry, or any other suitable circuitry.

The server device(s) 104, the client devices, such as client device 112, and the database 108 may communicate with each other via the network 106. In general, the network 106 can be any combination of connections and protocols capable of supporting communication between the server device(s) 104, the database 108, a client device, such as client device 112, and the bot detection system 102. For example, the network 106 may be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. In one or more cases, the network 106 may include wire cables, wireless communication links, fiber optic cables, routers, switches, firewalls, or any combination that can include wired, wireless, or fiber optic connections known by those skilled in the art. Though FIG. 1 illustrates the components of environment 100 communicating via the network 106, it will be appreciated that the components of environment 100 may communicate directly with each other, for example, bypassing the network 106. For example, the client device 112 may communicate directly with the server device(s) 104 and bot detection system 102.

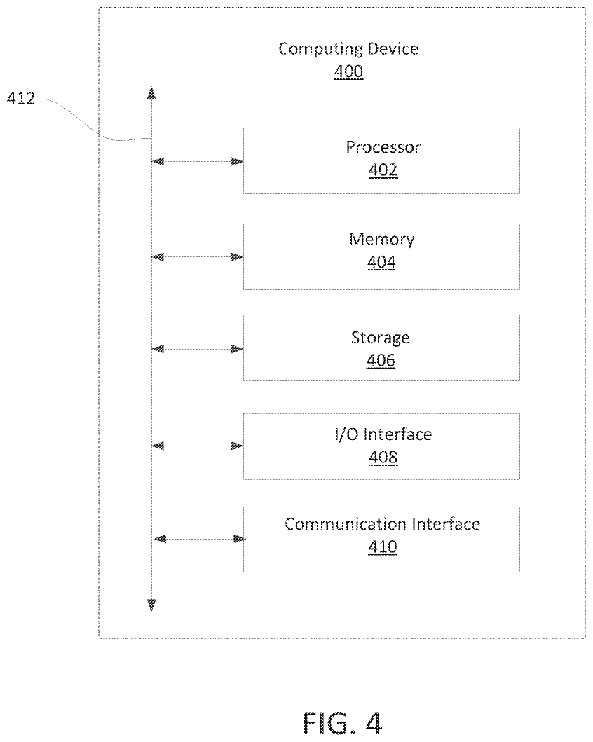

In one or more cases, the server device(s) 104 hosts the bot detection system 102. In some cases, the server device(s) 104 may be a web server, a blade server, a mobile computing device, a laptop computer, a tablet computer, a netbook computer, a personal computer (PC), a desktop computer, or any programmable electronic device or computing system capable of receiving and sending data, via the network 106, and performing computer-readable program instructions. In one or more cases, the server device(s) 104 may communicate with a client device, such as the client device 112. For example, the server device(s) 104 may send data to the client device 112, including challenge data, data associated with a request to access one or more portions of a website, data corresponding to instructions to terminate a session, or other information, and the server device(s) 104 may receive input from a user via client device 112. In some cases, the server device(s) 104 may include a distributed collection of servers, in which the server device(s) 104 include a number of server devices distributed across the network 106. In some examples, the distributed server device(s) 104 may be located in the same location or at different physical locations. In other cases, the server device(s) 104 may comprise a content server, an application server, a communication server, a web-hosting server, or another type of server. In one or more cases, the bot detection 102 may be implemented in hardware. In one or more examples, the bot detection 102 may be implemented as an executable program maintained in a tangible, non-transitory memory, such as memory 404 of FIG. 4, which may be executed by one or processors, such as processor 402 of FIG. 4.

The environment 100 may be included in a local network or local high-performance computing (HPC) system. In one or more other cases, the environment 100 may be included in a cloud computing environment comprising a plurality of server devices, such as server device(s) 104, having software and/or data distributed thereon. In one or more cases, the bot detection system 102 may be distributed across server devices 104 having access to the database 108 via the network 106 in a cloud-based computing system.

A client device, such as client device 112, may generate, store, receive, and/or send digital data to interact with a website when performing a challenge-response authentication via the processes and analysis described herein. For example, the client device 112 may receive challenge data corresponding to a challenge question. The client device 112 may communicate with the server device(s) 104 to provide data corresponding to a response to the challenge question. In one or more cases, the client device 112 may present or display information pertaining to the challenge-response authentication processes within a graphical user interface of a webpage of a web-browser displayed on the client device 112.

The client devices may include various types of client devices. For example, the client device 112 may be a non-mobile device, such as desktop computer, server, or the like. In another example, the client device 110 may be a mobile device, such as a laptop, tablet, mobile telephone, smartphone, or the like.

The client device, such as client device 112, includes a user interface for providing an end user with the capability to interact with the bot detection system 102. For example, an end user of the client device 112 may access the bot detection system 102 through a user interface to view, access, and interact with a website hosted on the server device(s) 104. The user interface refers to the information (such as graphic, text, and sound) a program presents to a user and the control sequences the user employs to control the program. The user interface can be a graphical user interface (GUI). A GUI may allow users to interact with electronic devices, such as a keyboard and mouse, through graphical icons and visual indicators, such as secondary notations, as opposed to text-based interfaces, typed command labels, or text navigation. For example, the GUI may allow users to view, access, and interact with a website hosted on the server device(s) 104.

In one or more cases, the database 108 may store data including, but not limited to, challenge data, data associated with a request to access one or more portions of a website, data corresponding to instructions to terminate a session, identifiers of a client device (e.g., an IP address), and the like. In one or more cases, the data may be stored and localized on the database 108. However, it should be understood that this data may be stored in multiple databases. The database 108 may be one of, a web server, a mobile computing device, a laptop computer, a tablet computer, a netbook computer, a personal computer (PC), a desktop computer, or any programmable electronic device or computing system capable of receiving, storing, sending data, and performing computer readable program instructions capable of communicating with the server device(s) 104, and one or more of client devices 110 and 112, via network 106. In one or more cases, the database 108 may represent virtual instances operating on a computing system utilizing clustered computers and components (e.g., database server computer, application server computers, etc.) that act as a single pool of seamless resources when accessed within data processing environment 100. In one or more cases, the database 108 may be a remote storage device. In one or more other cases, the database 108 may be a local storage device on the server device(s) 104. For example, the database 108 may be, but not limited to, a hard drive, non-volatile memory, or a USB stick.

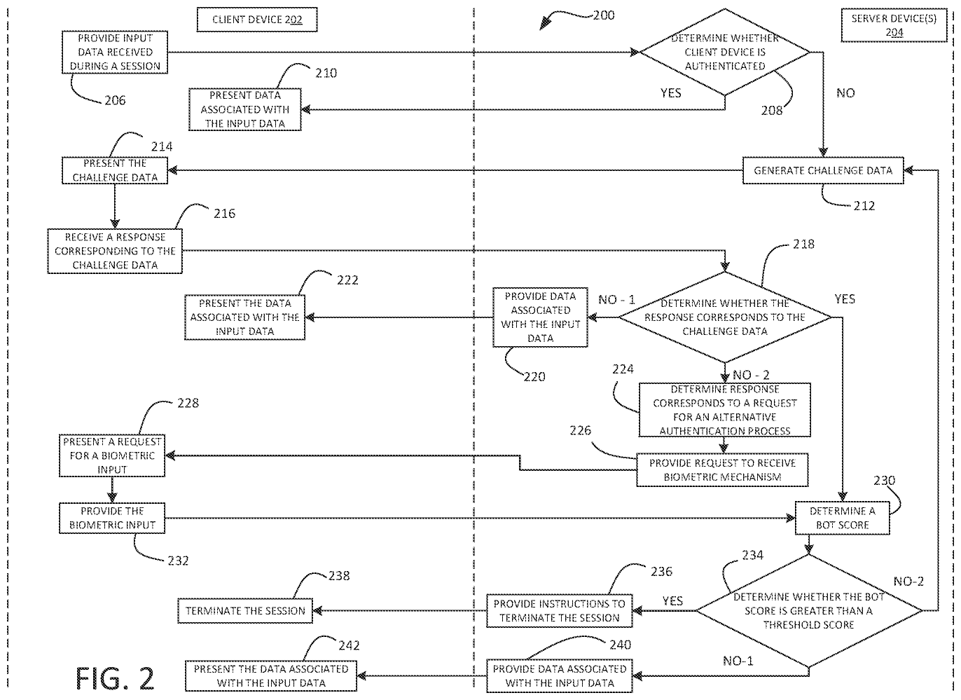

FIG. 2 is a flowchart that illustrates a challenge-response authentication procedure 200 for authenticating a valid user in a digital interaction. For instance, FIG. 2 illustrates an example of the challenge-response authentication procedure 200 between client device 202 and server device(s) 204. Server device(s) 204 may include one or more of the same or similar features as server device(s) 104, and as such the same or similar features are not repeated herein. Client device 202 may include one or more of the same or similar features as client devices 110 and 112, and as such the same or similar features are not repeated herein. One or more portions of the procedure 200 may be stored in memory as computer-readable or machine-readable instructions that may be executed by a processor of the one or more computing devices. Though portions of the procedure 200 may be described herein as being performed by a bot detection system or server device(s) 204, the procedure 200, or portions thereof, may be performed by another computing device or distributed across multiple computing devices.

In one or more cases, the client device 202 may receive an input to access one or more portions and/or features of a website during a session. The input may correspond to performing a range of functions provided by the website. For example, the input may correspond to data instructing the website to display informational webpages (e.g., an “About Our Company” webpage, a “Contact Us” webpage, and the like). In another example, the input may correspond to data instructing the website to undertake an action having a certain level of security-risk (e.g., a request to create an account, request to edit account details, a request to close an account, and the like). The client device 202 may attempt to access one or more portions and/or features of the website, via, for example, but not limited to, Internet Protocol (IP), Transmission Control Protocol (TCP), HyperText Transfer Protocol (HTTP), and/or other network protocol messaging and/or data packets. The example described herein discusses a website as the interface, however, the invention is not limited thereto and may be implemented on other types of user interfaces, for example, but not limited to, physical devices (e.g., car remotes, conveyor belt operation devices)

The input data received during the session is provided (at 206), preferably by the client device 202. For example, the client device 202 may provide the input data to the server device 204 via the network (e.g., network 106 of FIG. 1). The client device 202 may provide the input data as a request that includes, for example, a Uniform Resource Locator (URL) or another identifier to access one or more portions and/or features of the website. For example, the client device 202 may provide the request (e.g., a login request to an account) as a HTTP packet that includes data requesting access to one or more portions and/or features of the website, such as but not limited to, an account associated with the website.

The server device 204 may receive the request and determine (at 208) whether the client device 202 is authenticated. By authenticating the client device 202, the server device 204 may determine (e.g., by inferring) that a user operating the client device 202 is a valid user (e.g., a human) and not an invalid user (e.g., a bot).

In one or more cases, the server device 204 may perform an initial authentication process based on data included and/or associated with the received request. In some cases, the server device 204 may grant access based on the type or area of the website being requested. For example, the server device 204 may authenticate and grant access to an informational webpage (e.g., an “About Our Company” webpage, a “Contact Us” webpage, and the like). In some additional or alternative cases, the server device 204 may authenticate the client device 202 by determining that the client device 202 was previously authenticated. For instance, the request may include an identifier of the client device 202, such as, but not limited to, an IP address of the client device 202. The server device 204 may perform a lookup of the IP address to determine whether the client device 202 has been previously authenticated. In some additional or alternative cases, the server device 204 may track one or more metrics corresponding to actions performed on the website by the client device 202 during the session. The metrics may include, for example, but not limited to, input duration of keystrokes being entered into a textbox, response times to select icons (e.g., selecting an icon to skip an advertisement or close a dialog or chat window), biometric input (e.g., voice, face, iris, fingerprint, palmprint), and the like.

For the cases in which the client device 202 is authenticated (208:YES), the server device 204 grants and provides access to the client device 202 to data associated with the request. The client device 202 may receive the data associated with the requested input to access one or more portions and/or features of a website, via the network. The data associated with the input data is presented (at 210), preferably by the client device 102. For example, the client device 102 may present within a graphical user interface (GUI) of the client device 102 a webpage (e.g., an “About Our Company” webpage) of the website that corresponds to the input data.

For the cases in which the client device 202 is not authenticated (208:NO), the server device 204 generates challenge data (at 212). In one or more cases, challenge data may be used to assess whether a user of the client device 202 is a human being or a bot. The challenge data corresponds to a challenge question.

In one or more cases, the challenge data includes challenge questions corresponding to varying degrees of difficulty. Unlike conventional challenge-response authentication solutions, the challenge data presented to the client device 202 includes questions having a high degree of complexity, such that a human would be unlikely to provide a correct response to the question. The degree of difficulty of the challenge question may be based on a variety of factors. For instance, a degree of difficulty associated with a challenge question may be determined based on one or more of age appropriateness, grade level, subject matter, specialized information, response time to answer a challenge question, an input duration (e.g., a number of keystrokes or mouse clicks) to answer a challenge question, and the like. For example, a challenge question that is age appropriate for an adult may be determined to have a higher degree of complexity than a challenge question that is age appropriate for a child. In another example, a challenge question that corresponds to information taught in postgraduate education, such as master's level courses or doctorate level courses, may be determined to have a high degree of complexity. For instance, challenge questions may correspond to solving a Linear Algebra problem or interpreting lines of computer code. In another example, challenge questions that correspond to information associated with knowledge generally known by specialists may be determined to have a high degree of complexity. For instance, challenge questions may correspond to diagnosing evidence of medical issues from images of a human body part, such as a heart, lungs, or eyes. In another instance, challenge questions may correspond to decrypting a cipher or code. In another example, challenge questions that are posed in a language or in multiple languages that differ from a user's device language settings may be determined to have a high degree of complexity. For instance, if a user's device settings identify English as the device language, the challenge questions may be presented in Spanish, Korean or a mixture thereof. In another example, a challenge may involve asking the user to meet highly precise measurement and time dependent actions such as click the mouse when the timer reads 2.888881 seconds, draw a line measuring 200 pixels within 2 seconds, or click “H” on the keyboard 12 times before or between a set time threshold. In other examples, variations on human neurological tests and optical illusions could be administered such as the challenge asking the user to draw a perfect circle with the mouse or touch screen within 2 seconds, type out the long sentence shown in the picture within 3 seconds (where the picture has a background and a font which differ by only 1 RBG/hue), or the user is asked to perform tasks that require rapid switching between mouse and keyboard inputs in response to changing cues on the screen.

In one or more cases, the degree of difficulty of the challenge question may be determined based on a challenge difficulty index score. The challenge difficulty index score may be used to assess a challenge question's actual degree of difficulty. In one or more cases, the challenge difficulty index score may be assigned when the challenge question is initially created. In one or more other cases, the challenge difficulty index score may be determined via a testing pool. For example, a challenge question may be presented to a number of known users (e.g., 100 people). The users may provide their response to the challenge question. The challenge difficulty index score may correspond to the proportion of the number of correct answers (e.g., 2 correct answers) to the number of wrong answers (e.g., 98 incorrect answers) to the challenge question to generate the challenge difficulty index score (e.g., 0.02). Based on the challenge difficulty index score, the challenge question may be grouped to an associated tier of the challenge difficulty index. For instance, the challenge difficulty index may have an easy degree of difficulty tier, a medium degree of difficulty tier, and a hard degree of difficulty tier. Each tier may be associated with a range of scores. For example, the challenge difficulty index score of the hard tier may range from 0 to 0.25, the challenge difficulty index score of the medium tier may range from 0.26 to 0.75, and the challenge difficulty index score of the easy tier may range from 0.76 to 1.0.

In one or more cases, the challenge data associated with an initial challenge question presented during a session may correspond to a challenge difficulty score within the hard tier range. That is, the initial challenge question presented during the session may have a high degree of difficulty. For example, the challenge question 302 may be “If (ax+2)(bx+7)=15x²+cx+14 for all values of x, and a+b=8, what are two possible values for c?”

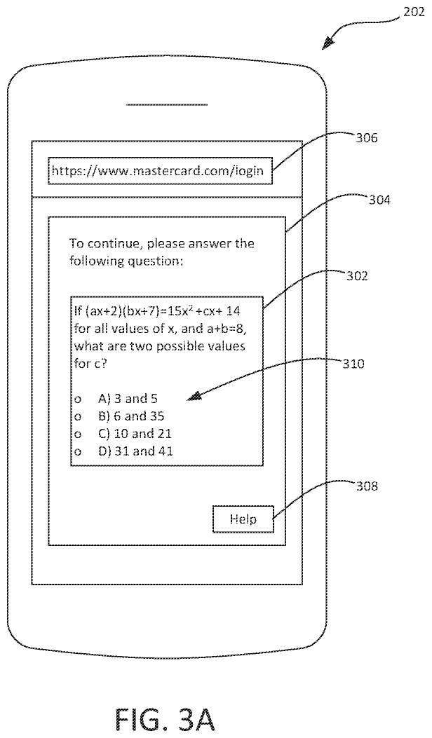

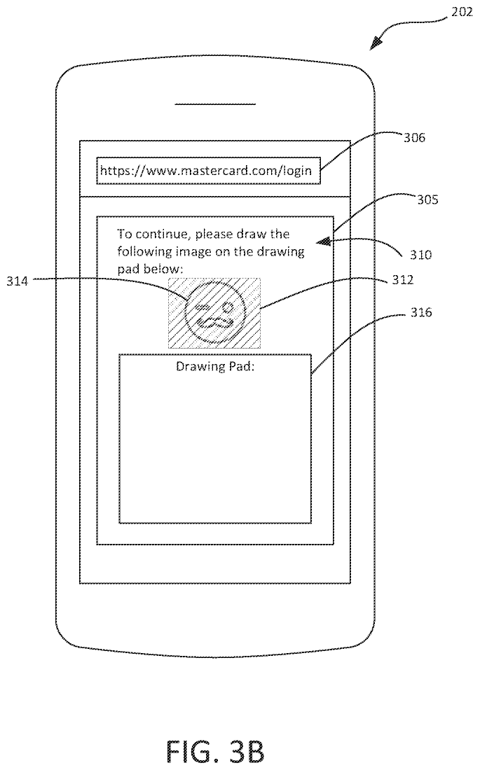

Having generated the challenge data, the server device 204 provides the challenge data to the client device 202. The client device 202 receives and presents (at 214) the challenge data. In one or more cases, the challenge question corresponding to the challenge data may be presented to the client device 202. For example, the client device 202 may display the challenge question (e.g., challenge question 302 as illustrated in FIG. 3A) within a graphical user interface of the client device 202 displaying the webpage of the website (e.g., webpage 304 of website 306 as illustrated in FIG. 3A).

In one or more cases, a response corresponding to the challenge data is received (at 216), preferable by the client device 202. In some cases, the client device 202 may receive a response that includes an answer to the challenge question. The response to the challenge question may be provided in a number of ways. For instance, the response to the challenge question 302 may include a selection of one of the answer options 310 (e.g., option A, option B, option C, and option D) displayed on webpage 304. In another instance, the response to a challenge question may include text input into a response window, in which the text corresponds to an answer to the respective challenge question. In some other cases, the client device 202 may receive a response that includes a selection of the help icon 308. The help icon 308 provides an avenue to express an inability to provide a correct response to the challenge question. In other words, a human user of client device 202 may select the help icon 308 as a response to the challenge question to indicate the human user's inability to solve the challenge question. As such, by selecting the help icon 308, the user may pass or decline to answer the challenge question.

Having received a response to the challenge question, the client device 202 provides data associated with the response to the server device 204. The data associated with the response may include, for example, but not limited to, one or more of data characterizing the response to the challenge question (e.g., one of a selection of option B of the answer options 310, a selection of option D of the answer options 310, or a selection of help icon 308), data characterizing an amount of time to present the challenge data and receive a response to the challenge data, data characterizing an amount of time to input a response into the corresponding area of the webpage, and the like.

The server device 204 determines (at 218) whether the data associated with the response corresponds to the challenge data. For example, the server determines whether the client device 202 provided a correct answer to the challenge question.

In some cases, the server device 204 may receive an incorrect answer to the challenge question. For example, the server device 204 may receive a selection of option B) 6 and 35 of the answer options 310 in response to challenge question 302. For the cases in which the server device 204 determines that the response to the challenge question is an incorrect answer (218:NO-1), the server device 204 may infer that the user of the client device 202 is a valid user (e.g., a human) and not an invalid user (e.g., a bot). The server device 204 provides data associated with the input data to the client device 202 (at 220). For example, the server device 204 may provide access to the account associated with the login request. Having received the data associated with the input data, the client device 202 presents (at 222) the data associated with the input data. For example, the client device 202 may present within the GUI of the client device 202 a webpage that displays account details that correspond to the login request. It is noted that the example provided herein describes receiving an incorrect answer to the initial challenge question and validating the user in response to receiving the correct answer, it should be understood that there may be cases in which one or more additional challenge questions may be presented to the client device 202 before the server device 204 determines to validate the user of the client device 202. For instance, having received an incorrect answer to the challenge question, the server device 204 provides challenge data corresponding to one or a series of additional challenge questions to the client device 202 in order to further determine whether the user of the client device 202 is a valid or invalid user. In some cases, the additional challenge questions may include varying degrees of difficulty that are randomly presented to the client device 202. For instance, after the initial challenge question, the server device 204 may present a challenge question having a challenge difficulty index score within the easy tier range, followed by a challenge question having a challenge difficulty index score within the hard tier range. By randomly presenting challenge questions having a variety of difficulties, the server device 204 may unpredictably assess whether a user of the client device 202 is a valid or invalid user.

In some other cases, the server 204 may receive a correct answer to the challenge question. For example, the server 204 may receive a selection of option D) 31 and 41 of the answer options 310 in response to challenge question 302. For the cases in which the server 204 determines that the response to the challenge question is a correct answer (218:YES), the server 204 may infer that the user of the client device 202 is an invalid user (e.g., a bot). In one or more cases, a bot score is determined (at 230), preferably by the server device 204. The bot score may be used to indicate a probability that a user of the client device 202 is an invalid user. The bot score may be compiled based on one or more factors, such as, but not limited to, receiving a correct or incorrect answer to the challenge question, a response time in providing an answer to the challenge question (e.g., the time in which it takes to receive an answer after presenting the challenge question to the client device 202), an input duration to provide an answer to the challenge question (e.g., the time in which keystrokes are entered into a textbox), an identifier of the client device 202 (e.g., an IP address associated with the client device 202), previous interactions with the user.

The server device 204 determines (at 234) whether the bot score is greater than a threshold score. For the cases in which the server device 204 determines that the bot score is greater than the threshold score (234:YES), the server device 204 provides instructions (at 236) to the client device 202 to terminate the session. As such, the server device 204 determines that there is a high probability that the user of the client device 202 is likely a bot based on the bot score being greater than the threshold score. The client device 202 receives the instructions to terminate the session. The client device 202 terminates the session (at 238). It is noted that although the example described herein discusses the server device 204 providing instructions to terminate that session, it should be understood that the server device 204 may provide alternative instructions to the client device 202 to mitigate or prohibit the user of the client device 202 from taking further actions. For instance, the server device 202 may provide instructions to the client device 202 to prohibit the client device 202 from accessing the account associated with the login request. It is also noted that although the example described herein discusses the client device 202 terminating the session (at 238), an orchestration layer may be present to receive instructions from the server device 204 (at 236) to terminate the session or to receive alternative instructions. The orchestration layer thereafter terminates the session or acts on the alternative instructions.

In one or more cases, the server device 204 stores an identifier (e.g., an IP address) of the client device 202 in a database (e.g., database 108 of FIG. 1). In some cases, the server device 204 may provide an indication to the database that a client device associated with the unique identifier was previously identified as having a high probability of being associated with an invalid user. In some cases, if the server device 204 determines in a future session that a client device is associated with a unique identifier in the database, the server device 204 may provide instructions to terminate the session. In other cases, if the server device 204 determines in a future session that a client device is associated with the unique identifier in the database, the server device 204 may include this factor in determining a bot score of the client device.

In one or more cases, the server device 204 may determine that the bot score is not greater than the threshold score. Based on a margin of difference between the bot score and the threshold score, the server device 204 may determine to issue another challenge question of provide access to the requested data. For instance, for the cases in which the server device 204 determines that the bot score is less than the threshold score by a large margin (234:NO-1), the server device 204 provides (at 240) data associated with the input data to the client device 202. For example, the server device 204 may provide access to the account associated with the login request. Having received the data associated with the input data, the client device 202 presents (at 242) the data associated with the input data. For example, the client device 202 may present within the GUI of the client device 202 a webpage that displays account details that correspond to the login request.

In one or more cases, the server device 204 stores an identifier (e.g., an IP address) of the client device 202 in a database (e.g., database 108 of FIG. 1). In some cases, the server device 204 may provide an indication to the database that a client device associated with the unique identifier was previously identified as having a low probability of being associated with an invalid user. In some cases, if the server device 204 determines in a future session that a client device is associated with the unique identifier in the database, the server device 204 may provide instructions to grant access to the requested one or more portions and/or features of a website. In other cases, if the server device 204 determines in a future session that a client device is associated with the unique identifier in the database, the server device 204 may include this factor in determining a bot score of the client device.

In other cases, the server device 204 may determine that the bot score is not greater than the threshold score by a different margin. For instance, for the cases in which the server device 204 determines that the bot score is less than the threshold score by a small margin (234:NO-2), the server device 204 generates challenge data (at 212) and provides the challenge data to the client device 202 to repeat the challenge-response authentication process again, as described herein. The server device 204 may provide challenge data corresponding to one or a series of additional challenge questions to the client device 202 in order to further determine whether the user of the client device 202 is a valid or invalid user. The additional challenge questions may include varying degrees of difficulty that are randomly presented to the client device 202. For instance, the server device 204 may present another challenge question having a challenge difficulty index score within the easy tier range, followed by a challenge question having a challenge difficulty index score within the hard tier range. In some cases, the responses to the one or more additional challenge questions may be compiled, for example, by the client device 202, and provided to the server device 204 for further evaluation, as described herein. In other cases, the responses to the one or more additional challenge questions may be provided to the server device 204 by the client device 202 as the responses are received.

In some cases, the server 204 may receive a selection of a help icon in response to the challenge question. For example, the server 204 may receive a selection of the help icon 308 in response to challenge question 302, as illustrated in FIG. 3A. By receiving a selection of the help icon 308, the server device 204 may infer that a client device expressed an inability to solve the challenge question and/or pass or decline to answer the instant challenge question (e.g., challenge question 302). For the cases in which the server 204 determines that the client device 202 expressed an inability to solve the challenge question (e.g., via a selection of the help icon 308) (218:NO-2), the server device 204 determines (at 224) that the response corresponds to a request to receive another authentication process.

In one or more cases, the server device 204 may provide, as an alternative authentication process, challenge data corresponding to one or a series of additional challenge questions to the client device 202 that randomly vary in degrees of difficulty. The responses to the one or more additional challenge questions may be compiled and provided to the server device 204 for further evaluation, as described herein.

In one or more other cases, the server device 204 may provide, as an alternative authentication process, a request to receive an input of a biometric (at 226) from the client device 202. The client device 202 may present (at 228) the request for a biometric input. A biometric input may be an action performed or input into the client device 202 that further distinguished human actions from a bot. For example, the client device 202 may present a web-page 305 with a request 310 for a type of biometric input (e.g., drawing an image), as illustrated in FIG. 3B. For instance, the request 310 may indicate the “To continue, please draw the following image on the drawing pad below:”. In some cases, the image 314 may be a simple image, such as a smiley face, that a human could draw. In other cases, the image 314 may be obfuscated, for example, with a semi-transparent image 312 overlaid on the image 314. The obfuscated image 312 and 314 may allow a human to view and recreate the underlaying image 314 while increasing the complexity if a bot were to apply an image processing technique to determine the appropriate image to recreate on the drawing pad 316. A user may recreate the image 314 on the drawing pad 316 by drawing the image with a finger, stylus, or cursor based on the capabilities of the client device 202. For instance, if the client device 202 is a desktop computer (e.g., client device 112 of FIG. 1), the user may draw the image 314 using a mouse coupled to the client device 112. In another instance, if the client device 202 has touch screen capabilities (e.g., client device 110 of FIG. 1), the user may draw the image 314 with a finger or stylus.

Other types of biometric inputs may include, for example, but not limited to, typing a response to a prompt in a textbox (e.g., “Please enter the following text: ‘I am not a bot.’”); recording a voice response or video response to a prompt (e.g., “Please repeat the following phrase into your microphone: ‘I am not a bot.’”); capturing an image using the client device in response to a prompt (e.g., “Please upload a picture of your pet”); and the like.

Having received the biometric input, the client device provides (at 232) data associated with the biometric input to the server device 204. The data associated with the biometric input may be used to determine a bot score (at 230). As described herein, the bot score may be used to indicate a probability that a user of the client device 202 is an invalid user. The bot score may be compiled based on one or more factors, such as, but not limited to, receiving a correct or incorrect answer to the request for a type of biometric input (e.g., an accuracy of the drawing of the image 314), a response time in providing the biometric input (e.g., the time in which it takes to draw the image 314 on the drawing pad 316), an input duration to provide an answer to the challenge question (e.g., the time in which keystrokes are entered into a textbox), an identifier of the client device 202 (e.g., an IP address associated with the client device 202). Based on the determined bot score, the server device 204 determines whether to present additional challenge questions, terminate the respective session, or provide data associated with the respective input data as discussed herein.

FIG. 4 is a block diagram illustrating an example computing device 400. One or more computing devices such as the computing device 400 may implement one or more features for authenticating valid users in digital interactions, as described herein. For example, the computing device 400 may comprise the client device 112 and/or the server device(s) 102 shown in FIG. 1. As shown by FIG. 4, the computing device 400 may comprise a processor 402, a memory 404, a storage device 406, an I/O interface 408, and/or a communication interface 410, which may be communicatively coupled by way of a communication infrastructure 412. It should be appreciated that the computing device 400 may include fewer or more components than those shown in FIG. 4.

The processor 402 may include hardware for executing instructions, such as those making up a computer program. In examples, to execute instructions for dynamically modifying workflows, the processor 402 may retrieve (or fetch) the instructions from an internal register, an internal cache, the memory 404, or the storage device 406 and decode and execute the instructions. The memory 404 may be a volatile or non-volatile memory used for storing data, metadata, computer-readable or machine-readable instructions, and/or programs for execution by the processor(s) for operating as described herein. The storage device 406 may include storage, such as a hard disk, flash disk drive, or other digital storage device, for storing data or instructions for performing the methods described herein.

The I/O interface 408 may allow a user to provide input to, receive output from, and/or otherwise transfer data to and receive data from the computing device 400. The I/O interface 408 may include a mouse, a keypad or a keyboard, a touch screen, a camera, an optical scanner, network interface, modem, other known I/O devices or a combination of such I/O interfaces. The I/O interface 408 may include one or more devices for presenting output to a user, including, but not limited to, a graphics engine, a display (e.g., a display screen), one or more output drivers (e.g., display drivers), one or more audio speakers, and one or more audio drivers. The I/O interface 408 may be configured to provide graphical data to a display for presentation to a user. The graphical data may be representative of one or more graphical user interfaces and/or any other graphical content.

The communication interface 410 may include hardware, software, or both. In any event, the communication interface 410 may provide one or more interfaces for communication (such as, for example, packet-based communication) between the computing device 400 and one or more other computing devices or networks. The communication may be a wired or wireless communication. As an example, and not by way of limitation, the communication interface 410 may include a network interface controller (NIC) or network adapter for communicating with an Ethernet or other wire-based network or a wireless NIC (WNIC) or wireless adapter for communicating with a wireless network, such as a WI-FI.

Additionally, the communication interface 410 may facilitate communications with various types of wired or wireless networks. The communication interface 410 may also facilitate communications using various communication protocols. The communication infrastructure 412 may also include hardware, software, or both that couples components of the computing device 400 to each other. For example, the communication interface 410 may use one or more networks and/or protocols to enable a plurality of computing devices connected by a particular infrastructure to communicate with each other to perform one or more aspects of the processes described herein. To illustrate, the compliant and optimized peer data set generation process may allow a plurality of devices (e.g., a client device and server device(s)) to exchange information, such as compliant peer set data.

In addition to what has been described herein, the methods and systems may also be implemented in a computer program(s), software, or firmware incorporated in one or more computer-readable media for execution by a computer(s) or processor(s), for example. Examples of computer-readable media include electronic signals (transmitted over wired or wireless connections) and tangible/non-transitory computer-readable storage media. Examples of tangible/non-transitory computer-readable storage media include, but are not limited to, a read only memory (ROM), a random-access memory (RAM), removable disks, and optical media such as CD-ROM disks, and digital versatile disks (DVDs). When the computer program code is loaded into and executed by a computer, the computer becomes an apparatus for practicing the embodiments. The embodiments may also be at least partially implemented in the form of a computer into which computer program code is loaded or executed, such that, the computer becomes a special purpose computer for practicing the embodiments. When implemented on a general-purpose processor, the computer program code segments configure the processor to create specific logic circuits. The embodiments may alternatively be at least partially implemented in application specific integrated circuits for performing the embodiments.

Although the embodiments discussed herein are described with reference to the figures, it will be appreciated that many other ways of performing the acts associated with the embodiments can be used. For example, the order of some operations may be changed, and some of the operations described may be optional.

The foregoing is provided for purpose of illustrating, explaining, and describing embodiments of this disclosure. Modifications and adaptations to the embodiments will be apparent to those skilled in the art and may be made without departing from the scope or spirit of the disclosure. Accordingly, the above description of example embodiments does not constrain this disclosure.

What is claimed is:

1. A computer-implemented method to, the method comprising:
receiving, from a device, a request to access one or more portions of a website during a session;
providing challenge data to the device to assess whether a user of the device is an invalid user, wherein the challenge data corresponds to a challenge question having a high degree of difficulty;
receiving data from the device, wherein the received data corresponds to an answer to the challenge question;
determining that the received data corresponds to a correct answer to the challenge question and that the user of the device is an invalid user; and
denying the requested access to the one or more portions of the website.

2. The computer-implemented method of claim 1, wherein the degree of difficulty of the challenge question is based on one or more of age appropriateness, grade level, and subject matter.

3. The computer-implemented method of claim 1, wherein the degree of difficulty of the challenge question is based on an index score that corresponds to a proportion of a number of correct answers to a number of incorrect answers to the challenge question.

4. The computer-implemented method of claim 1, wherein the invalid user comprises a bot.

5. The computer-implemented method of claim 1, further comprising terminating the session in response to determining that the user of the device is an invalid user.

6. The computer-implemented method of claim 1, further comprising determining that the received data corresponds to an incorrect answer to the challenge question and validating the user of the device.

7. The computer-implemented method of claim 6, further comprising providing to the device data associated with the requested access to the one or more portions of the website.

8. The computer-implemented method of claim 1, further comprising determining, in response to the received data corresponding to the correct answer to the challenge question, a score that indicates a probability that the user of the device is an invalid user.

9. The computer-implemented method of claim 8, wherein in response to determining that the score is not greater than a threshold, providing additional challenge data to the device, wherein the additional challenge data corresponds to one or more challenge questions having varying degrees of difficulty.

10. The computer-implemented method of claim 8, wherein in response to determining that the score is not greater than a threshold, validating the user of the device and providing to the device data associated with the requested access to the one or more portions of the website.

11. The computer-implemented method of claim 1, further comprising:
receiving data from the device requesting an alternative authentication process;
providing a request to the device for a biometric input;
receiving, from the device, data corresponding to the requested biometric input; and
determining a score that indicates a probability that the user of the device is an invalid user.

12. An apparatus, comprising:
a memory configured to store instructions; and
at least one processor coupled to the memory, the at least one processor configured to execute the instructions to:
receive, from a device, a request to access one or more portions of a website during a session;
provide challenge data to the device to assess whether a user of the device is an invalid user, wherein the challenge data corresponds to a challenge question having a high degree of difficulty;
receive data from the device, wherein the received data corresponds to an answer to the challenge question;
determine that the received data corresponds to a correct answer to the challenge question and that the user of the device is an invalid user; and
deny the requested access to the one or more portions of the website.

13. The apparatus of claim 12, wherein the degree of difficulty of the challenge question is based on one or more of age appropriateness, grade level, subject matter, and an index score that corresponds to a proportion of a number of correct answers to a number of incorrect answers to the challenge question.

14. The apparatus of claim 12, wherein the invalid user comprises a bot.

15. The apparatus of claim 12, wherein the at least one processor is further configured to terminate the session in response to determining that the user of the device is an invalid user.

16. The apparatus of claim 12, wherein the at least one processor is further configured to determine that the received data corresponds to an incorrect answer to the challenge question and validating the user of the device.

17. The apparatus of claim 16, wherein the at least one processor is further configured to provide to the device data associated with the requested access to the one or more portions of the website.

18. The apparatus of claim 12, wherein the at least one processor is further configured to determine, in response to the received data corresponding to the correct answer to the challenge question, a score that indicates a probability that the user of the device is an invalid user.

19. The apparatus of claim 18, wherein the at least one processor is further configured to, in response to determining that the score is not greater than a threshold, provide additional challenge data to the device, wherein the additional challenge data corresponds to one or more challenge questions having varying degrees of difficulty.

20. The apparatus of claim 12, wherein the at least one processor is further configured to:
receive data from the device requesting an alternative authentication process;
provide a request to the device for a biometric input;
receive, from the device, data corresponding to the requested biometric input; and
determine a score that indicates a probability that the user of the device is an invalid user.
